(19) United States
(12) Patent Application Publication
(10) Pub. No.: US 2025/0374894 A1
(43) Pub. Date: Dec. 11, 2025

(54) FEEDER TRAY APPARATUS

(71) Applicant: Oscar Jackson, Coconut Creek, FL (US)

(72) Inventor: Oscar Jackson, Coconut Creek, FL (US)

(21) Appl. No.: 18/735,389

(22) Filed: Jun. 6, 2024

(51) Int. Cl. A01K 39/04

(52) U.S. Cl. CPC A01K 39/04

(57) ABSTRACT

A feeder tray apparatus for containing food and water for birds or other animals includes a base which defines a hole that extends therethrough. An outer perimeter wall is coupled to and extends upwardly from an outer edge of the base. An inner perimeter wall coupled to and extends upwardly from an inner edge of the base. The base, the outer perimeter wall, and the inner perimeter wall define a cavity to hold a consumable substance such as birdseed, water, or other food or drink.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to feeding trays and more particularly pertains to a new feeding tray for containing food and water for birds or other animals.

### (2) Description of Related Art Including Information Disclosed Under 37 CFR 1.97 and 1.98

The prior art relates to feeding trays. U.S. Pat. No. 3,924,573 discloses a feeding tray with compartments that have a rear wall that is taller than a front wall, which facilitates access to contents of the contents by an animal when the feeding tray is mounted against an external wall. However, the prior art fails to describe a feeding tray with an annular shape that has an outer wall greater in height than an inner wall so that contents of the feeding tray are less likely to spill outwardly from the feeding tray when an animal consumes the contents while positioned inwardly of the feeding tray.

### BRIEF SUMMARY OF THE INVENTION

An embodiment of the disclosure meets the needs presented above by generally comprising a base which defines a hole that extends therethrough. An outer perimeter wall is coupled to and extends upwardly from an outer edge of the base. An inner perimeter wall coupled to and extends upwardly from an inner edge of the base. The base, the outer perimeter wall, and the inner perimeter wall define a cavity to hold a consumable substance such as birdseed, water, or other food or drink.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a feeder tray apparatus according to an embodiment of the disclosure.

FIG. 2 is a top view of an embodiment of the disclosure.

FIG. 3 is a bottom view of an embodiment of the disclosure.

FIG. 4 is a cross-section view of an embodiment of the disclosure taken from Line 4-4 in FIG. 2.

FIG. 5 is an in-use view of an embodiment of the disclosure.

### DETAILED DESCRIPTION OF THE INVENTION

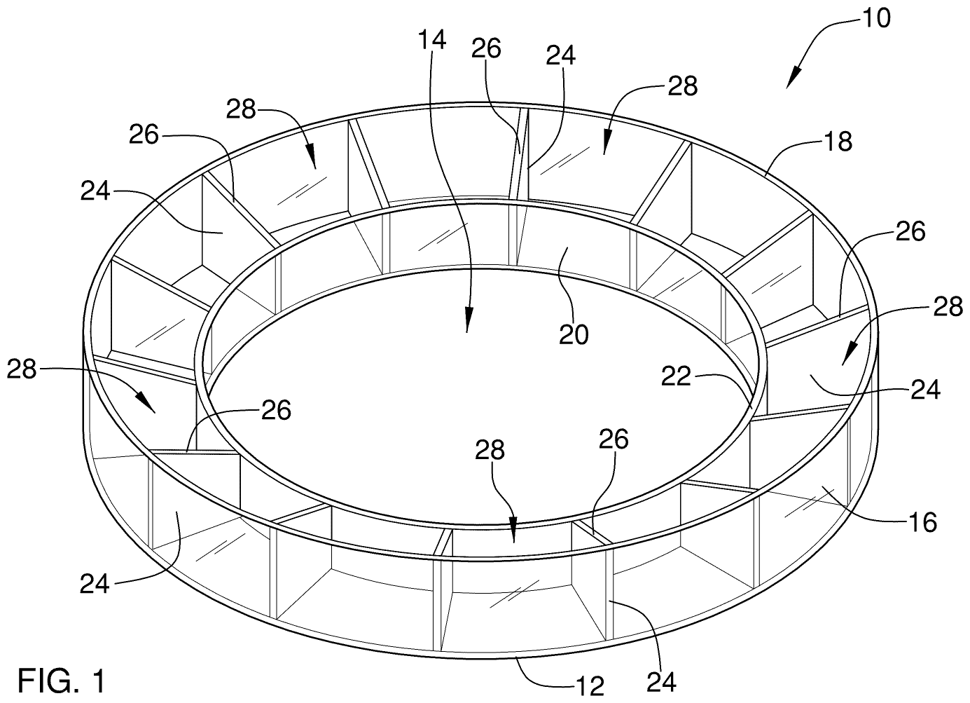

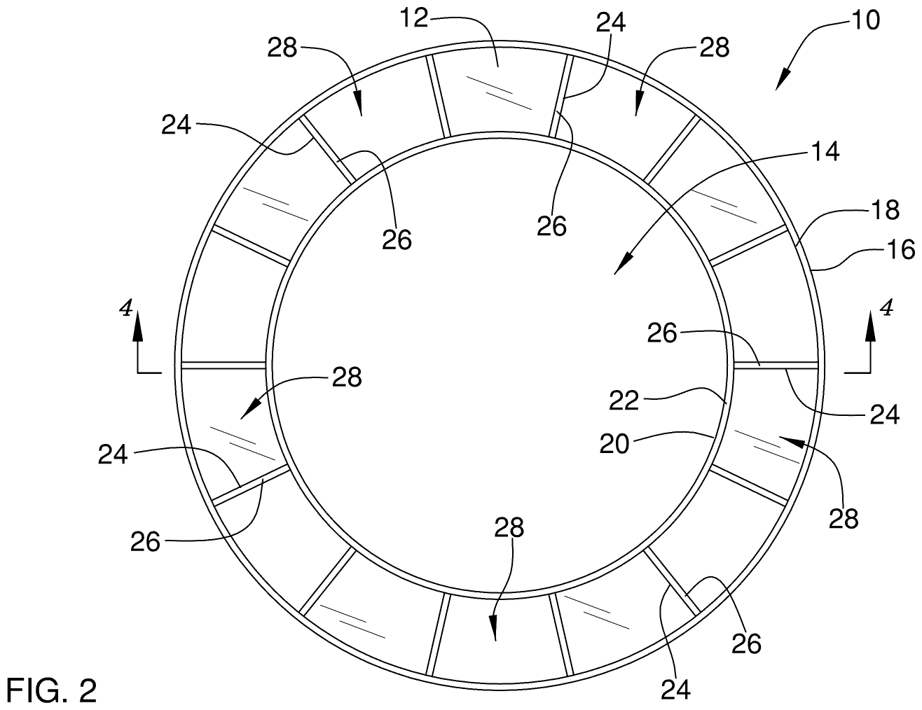

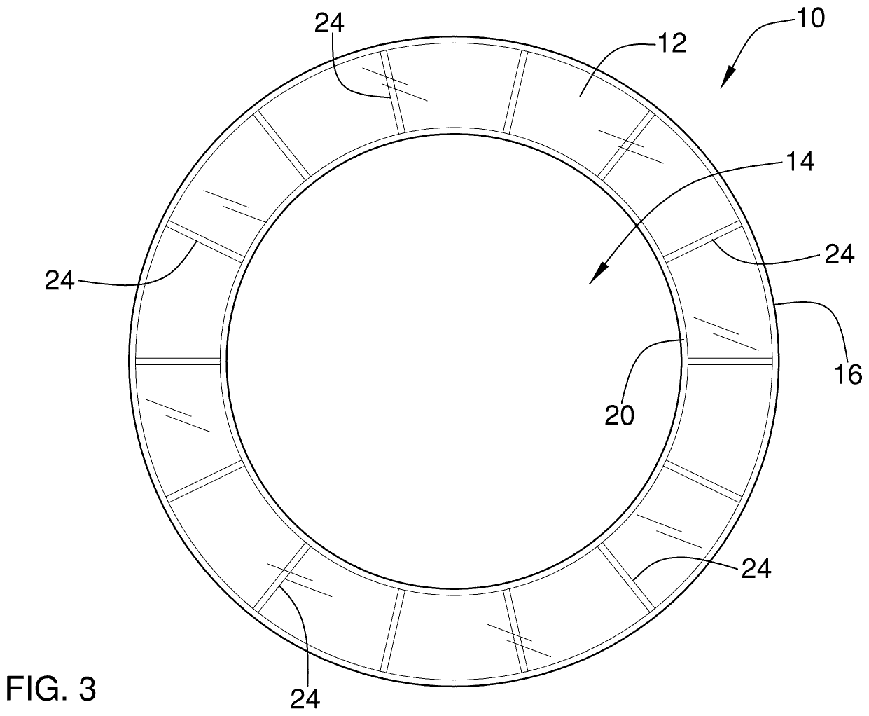

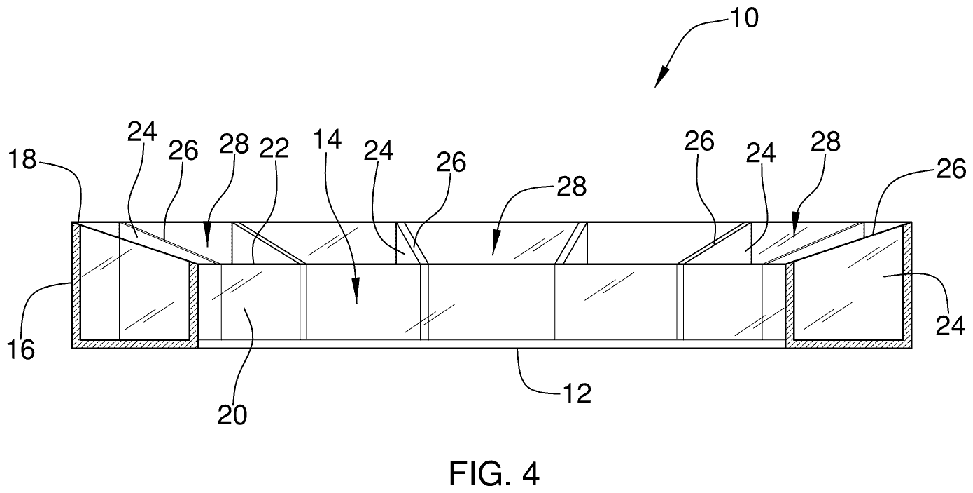

With reference now to the drawings, and in particular to FIGS. 1 through 5 thereof, a new feeding tray embodying the principles and concepts of an embodiment of the disclosure and generally designated by the reference numeral 10 will be described.

As best illustrated in FIGS. 1 through 5, the feeder tray apparatus 10 generally comprises a base 12 which defines a hole 14 that extends therethrough. The base 12 has an annular shape. An outer perimeter wall 16 is coupled to and extends upwardly from an outer edge of the base 12. An inner perimeter wall 20 is coupled to and extends upwardly from an inner edge of the base 12. The inner perimeter wall 20 has a height less than a height of the outer perimeter wall 16.

A plurality of dividers 24 is coupled to the base 12, the outer perimeter wall 16, and the inner perimeter wall 20. Each divider 24 extends from the inner perimeter wall 20 to the outer perimeter wall 16. The dividers 24 are spaced apart from each other radially around the hole 14 of the base 12 to define a plurality of compartments 28 with the base 12, the outer perimeter wall 16, and the inner perimeter wall 20. A top edge 26 of each divider 24 of the plurality of dividers 24 extends from an upper edge 22 of the inner perimeter wall 20 to a topmost edge 18 of the outer perimeter wall 16. The base 12, the outer perimeter wall 16, and the inner perimeter wall 20 comprise a transparent material. In some embodiments, the dividers 24 may also comprise the transparent material. The transparent material may be a clear plastic, glass, or other suitable material so that contents of the compartments 28 are viewable through the transparent material.

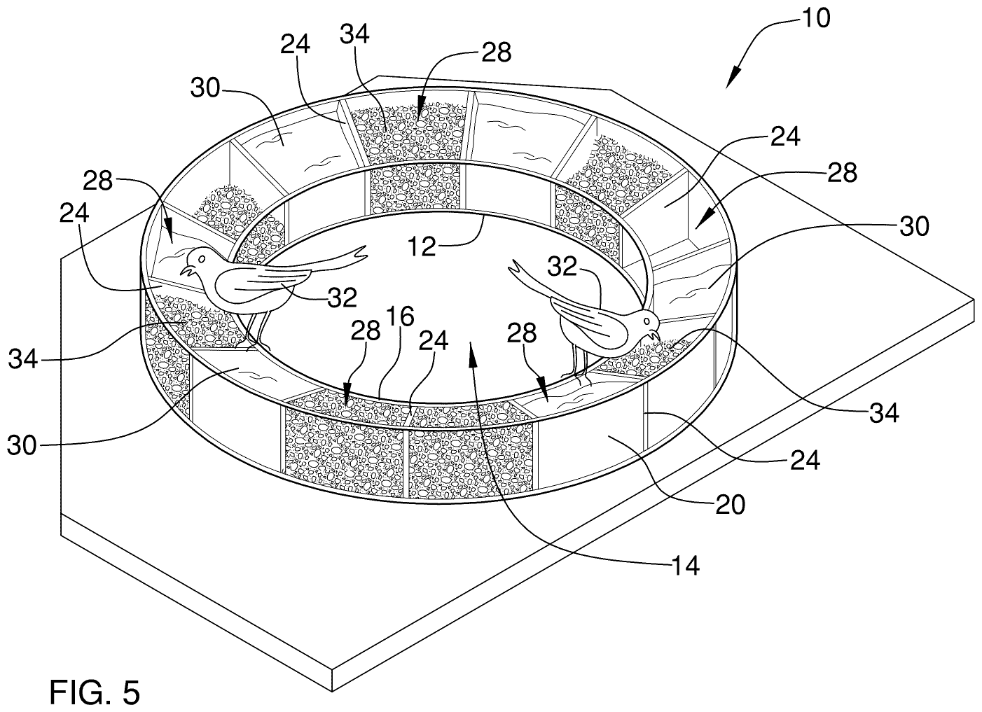

In use, food, water 30, or other fluids are placed in the compartments 28 for an animal to consume. As shown in FIG. 5, birdseed 34 may be placed in some of the compartments 28 while water 30 is placed in other ones of the compartments 28. The height difference between the outer perimeter wall 16 and the inner perimeter wall 20 helps keep birdseed 34, water 30, or other substances from spilling out over the outer perimeter wall 16 when the animal is consuming the substances while positioned inwardly of the base 12. The contents of the compartments 28 are more likely to spill inwardly than outwardly away from the feeding animal. Substances may be placed as desired by a user in selected compartments 28. The user may view the contents of the compartments 28 through the transparent material and replace them as necessary.

The heights of the inner perimeter wall 20 and the outer perimeter wall 16 may be formed such that a bird 32 or other animal may reach the contents of the compartments 28 while being positioned inwardly of the base 12 while being blocked from reaching the compartments 28 when standing outwardly of the base 12. For example, the height of the inner perimeter wall 20 may be less than a vertical distance from the bottoms of a bird's feet to the bird's beak when the bird is standing upright while the height of the outer perimeter wall 16 may be greater than this vertical distance.

Such heights may encourage the bird 32 or other animal to position itself inwardly of the base 12 while consuming the contents of the compartments 28. Being so positioned, the animal is viewable head-on from a viewer positioned outwardly of the feeder tray apparatus 10. Such design is advantageous for caged animals like birds, wherein the feeder tray apparatus 10 will be placed in a cage that doesn't contain the viewer. At all times, the viewer will then be facing inwardly with respect to the feeder tray apparatus 10 when viewing the cage and may view the faces of feeding animals rather than their rear ends.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A feeder tray apparatus comprising:
a base, the base defining a hole which extends through the base;
an outer perimeter wall coupled to and extending upwardly from an outer edge of the base;
an inner perimeter wall coupled to and extending upwardly from an inner edge of the base;
wherein the base, the outer perimeter wall, and the inner perimeter wall define a cavity to hold a consumable substance;
wherein the inner perimeter wall has a height less than a height of the outer perimeter wall; and
a plurality of dividers coupled to the base, the outer perimeter wall, and the inner perimeter wall, the dividers being spaced apart from each other around the hole of the base, the plurality of dividers defining a plurality of compartments with the base, the outer perimeter wall, and the inner perimeter wall, wherein a top edge of each divider of the plurality of dividers extends from an upper edge of the inner perimeter wall to a topmost edge of the outer perimeter wall.

2. (canceled)

3. (canceled)

4. (canceled)

5. The apparatus of claim 1, wherein the base has an annular shape.

6. The apparatus of claim 1, wherein the base, the outer perimeter wall, and the inner perimeter wall comprise a transparent material.

7. A feeder tray apparatus comprising:
a base, the base defining a hole which extends through the base, the base having an annular shape;
an outer perimeter wall coupled to and extending upwardly from an outer edge of the base;
an inner perimeter wall coupled to and extending upwardly from an inner edge of the base, the inner perimeter wall having a height less than a height of the outer perimeter wall;
a plurality of dividers coupled to the base, the outer perimeter wall, and the inner perimeter wall, the dividers being spaced apart from each other around the hole of the base, the plurality of dividers defining a plurality of compartments with the base, the outer perimeter wall, and the inner perimeter wall, a top edge of each divider of the plurality of dividers extending from an upper edge of the inner perimeter wall to a topmost edge of the outer perimeter wall; and
wherein the base, the outer perimeter wall, and the inner perimeter wall comprise a transparent material.
